(19) United States
(12) Patent Application Publication
(10) Pub. No.: US 2026/0259159 A1
(43) Pub. Date: Sep. 3, 2026

(54) DEW POINT METER, COMPONENTS THEREOF, AND METHODS OF USE THEREOF

(71) Applicant: Washington University, St. Louis, MO (US)

(72) Inventors: Mao CHENG, St. Louis, MO (US); Richard AXELBAUM, St. Louis, MO (US); Zachariah WARGEL, St. Louis, MO (US)

(21) Appl. No.: 19/163,543

(22) PCT Filed: Mar. 1, 2024
(86) PCT No.: PCT/US24/17946

§ 371 Date: Sep. 9, 2025

Related U.S. Application Data
(60) Provisional application No. 63/489,267, filed on Mar. 9, 2023.

(51) Int. Cl. G01N 25/68; G01N 25/70

(52) U.S. Cl. CPC G01N 25/68; G01N 25/70

(57) ABSTRACT

In one aspect, the present disclosure is directed to a sample cell for a dew point meter, the sample cell comprising: a flow channel configured to receive a gas sample, the flow channel comprising: a non-mirror window surface, wherein the flow channel is configured to allow a first optical beam originating from an optical source to impinge on the non-mirror window surface and output a second optical beam from the non-mirror window surface towards an optical detector.

### RELATED APPLICATION

This application claims the benefit of priority to U.S. Provisional Patent Application No. 63/489,267, filed Mar. 9, 2023, the contents of which are hereby incorporated by reference in their entirety.

### STATEMENT REGARDING FEDERALLY SPONSORED RESEARCH & DEVELOPMENT

This invention was made with government support under grant number DE-FE0031925 awarded by the Department of Energy. The government has certain rights in the invention.

### FIELD OF THE DISCLOSURE

The field of the disclosure relates generally to dew point meters, and, more specifically, to dew point meters useful for the measurement of the sulfuric acid dew point for industrial gas and combustion flue gas.

### BACKGROUND

For some energy, chemical and mine-related industrial processes, a small fraction of sulfur contained in raw materials is converted to sulfuric acid (H₂SO₄) vapor. H₂SO₄ vapor can condense into corrosive aqueous when the temperature is below the acid dew point, which may cause severe corrosion on equipment. For example, in industrial combustion processes, sulfur in fuel is converted to sulfur dioxide (SO₂) during combustion. A small percentage of the SO₂ is oxidized to sulfur trioxide (SO₃). The SO₃ further reacts to H₂SO₄ vapor when in the presence of water vapor. This process is shown in the reactions below.

Fuel-S+O₂→SO₂

SO₂+O₂→SO₃

SO₃+H₂O→H₂SO₄

Even with just trace levels of H₂SO₄ vapor in the gas phase (0.1-10 ppmv H₂SO₄, 10% vol H₂O) at atmosphere pressure, the acid dew point can reach around 100-135° C. To avoid acid condensation, plant engineers must ensure that surface temperatures are above the acid dew point, but this decreases the efficiency of the thermal energy recovery. Therefore, there is a trade-off between minimizing equipment corrosion and maximizing thermal energy recovery efficiency. The acid dew point is a key parameter to this optimization. Dew point meters for measuring the dew point of water vapor are available, but very few can measure the acid dew point due to the extreme corrosion and trace levels of H₂SO₄.

The commercial acid dew point meter is an electric conductivity sensor, which was based on the design from the British Coal Utilization Research Association (BCURA) around 1950. In this design, as shown in FIG. 1A, a glass thimble with two embedded electrodes on the surface is used to sense H₂SO₄—H₂O vapor condensation. The current between the electrodes will increase when an acid aqueous film forms. The glass surface is exposed to the flue gas flow and heated to above the acid dew point. The surface can be cooled by injecting compressed air into the glass inner surface. When the glass surface temperature is below the acid dew point, the H₂SO₄—H₂O vapor in the flue gas starts to condense on the surface. The two embedded electrodes fused with the glass surface are noble metals, which are H₂SO₄ corrosion resistant. An electrode (platinum-rhodium) in the glass surface center is also used as a thermocouple to measure the surface temperature. The ring-shaped electrode (platinum) surrounds the centered electrode. A voltage of 10 V at frequency of 100 Hz is applied to the electrodes, and the current is measured by a micro-amp current meter. The distance between the two electrodes is optimized to maximize measurement sensitivity. A large distance would require more condensates and thus decrease sensitivity. For a small distance, the vapor in the areas close to the electrodes would be difficult to condense due to the thermal effect of increased current to the electrodes.

Besides the sensor, the measurement algorithm is also important to measure the acid dew point. There are four common steps to measure the acid dew point based on electric conductivity:

First: Let the flue gas flow through the glass surface. Preheat the glass surface to the temperature above the estimated acid dew point.

Second: Measure a stable current of the acid dew point sensor without acid condensation, which should be close to zero.

Third: Slowly increase cooling air flow and decrease the glass surface temperature until the sensor current signal appears and increases. Adjust the air flow to get a stable current signal.

Fourth: Determine the acid dew point in terms of the sensor current signal and the surface temperature information.

In the BCURA design, when the sensor current signal is stable at 25 μA with adjusting the cooling air, the condensation rate is assumed to be equal to the evaporation rate. The measured temperature at this equilibrium point is assumed to be the acid dew point. AMETEK Land, which is a main supplier of acid dew point meters (FIG. 1B), uses a similar measurement principle developed by BCURA, while its stable current for the equilibrium point is 50 μA. However, these stable currents that are used to determine the acid dew point have not been validated. Further, this principle could greatly underestimate the acid dew point, as reported by BREEN company and Li et al. A tube-shaped acid dew point meter 200 based on a similar principle, as shown in FIG. 2, utilizes a Bakelite tube 202 includes a thermocouple 208 as well as negative electrodes 204 and positive electrodes 206 uniquely distributed in zig-zag manner. This design decreases the distance between electrodes to only 0.4 mm. In addition, the number of the sensing zones is greatly increased due to the zig-zag distribution of electrodes on the tube surface. Therefore, the measurement sensitivity is increased. However, the measurement results of this acid dew point meter have been shown to be greatly underestimated.

There are several challenges for the present acid dew point meters. First, to form the liquid film by condensing the trace levels of H₂SO₄ vapor results in a low measurement sensitivity, which can underestimate the acid dew point. Therefore, the commercial meters cannot measure a small acid dew point (<125° C.) with a low acid content (<5 ppm). Second, the reported results have been questioned by users, and there are no relevant calibration systems that can definitively demonstrate the accuracy of these meters.

To overcome these problems, in this disclosure a novel design for an acid dew point meter is proposed, which measures light scatterings to monitor acid condensates. Compared with the process of forming a liquid film that connects two electrodes, the scattering method requires only small droplets on a solid surface, which requires much less condensates to generate a detectable signal. This design can greatly enhance the measurement sensitivity, and thus enable an accurate measurement. The meter includes a novel optical instrument that is designed to monitor the slightest appearance of condensation on a hydrophobic window surface, and the surface temperature of the window is slowly decreased until condensation is first observed, yielding an accurate measurement of the dew point. The basis of the instrument is that a collimated beam from a diode laser generates scattered light when encountering surface condensate, and an array detector is used to sensitively monitor the light scattering. The measurement procedures are established to rapidly find the acid dew point, while minimizing error. Further, a calibration system is proposed based on the definition of acid dew point, which can generate a stable gas flow with known sulfuric acid dew point, to test the dew point meter. Test results show that the dew point meter can accurately measure the acid dew point over a wide range.

### BRIEF DESCRIPTION OF THE DISCLOSURE

In one aspect, the present disclosure is directed to a sample cell for a dew point meter, the sample cell comprising: a flow channel configured to receive a gas sample, the flow channel comprising: a non-mirror window surface, wherein the flow channel is configured to allow a first optical beam originating from an optical source to impinge on the non-mirror window surface and output a second optical beam from the non-mirror window surface towards an optical detector.

In another aspect, the present disclosure is directed to a method of measuring a dew point, the method comprising: (I) receiving a gas sample in a sample cell for a dew point meter, wherein the sample cell comprises: a flow channel configured to receive the gas sample, wherein the flow channel comprises: a non-mirror window surface, wherein the flow channel is configured to allow a first optical beam originating from an optical source to impinge on the non-mirror window surface and output a second optical beam from the non-mirror window surface towards an optical detector: (II) controlling a temperature of the non-mirror window surface and/or a portion of the gas sample to produce a liquid component on the non-mirror window surface and/or in the gas sample; and (III) measuring the dew point of the gas sample with the dew point meter.

### BRIEF DESCRIPTION OF THE DRAWINGS

FIG. 1A depicts a sensor of an acid dew point meter based on electric conductivity in a BCURA design.

FIG. 1B depicts a LANCOM 200 portable sulfuric acid dew point monitor.

FIG. 2 depicts electrodes on a wall of Bakelite tube as a sensor of an acid dew point meter.

FIG. 3 depicts a two-component (H₂SO₄—H₂O) phase equilibrium system, where p_{A} and p_{H}_{₂}_{O} are the partial pressures of H₂SO₄ vapor and H₂O vapor, respectively, and w_{A} and w_{H}_{₂}_{O} are the weight fractions of the H₂SO₄ and H₂O in the liquid phase, respectively.

FIG. 4 depicts a basic design of an acid dew point meter in accordance with the present disclosure.

FIG. 5A depicts a configuration of a dew point meter in accordance with the present disclosure including a window surface behind a non-mirror window surface.

FIG. 5B depicts a configuration of a dew point meter in accordance with the present disclosure including a reflected surface behind a non-mirror window surface, which reflects the first optical beam that is not encountered with a liquid component.

FIG. 5C depicts a configuration of a dew point meter in accordance with the present disclosure including a reflected surface behind a non-mirror window surface, which reflects a first beam that is encountered with a liquid component.

FIG. 6 depicts a basic design of a high-pressure dew point meter in accordance with the present disclosure.

FIG. 7 depicts a calibration system for an acid dew point meter in accordance with the present disclosure.

FIG. 8 depicts a mechanical design of a dew point meter cell under high pressure in accordance with the present disclosure.

FIG. 9 depicts a testing system for an acid dew point meter in accordance with the present disclosure.

FIG. 10 depicts that scattering signal intensities for an acid dew point meter in accordance with the present disclosure change when ramping down/up the hydrophobic window surface temperature, where the bubbler H₂SO₄ liquid temperature is 100° C. and the acid vapor content is around 170 ppm.

FIG. 11 depicts that scattering signal intensities for an acid dew point meter in accordance with the present disclosure change over time when reducing the window surface temperature, where the bubbler H₂SO₄ liquid temperature is 55.3° C. and the acid vapor content is around 6 ppm.

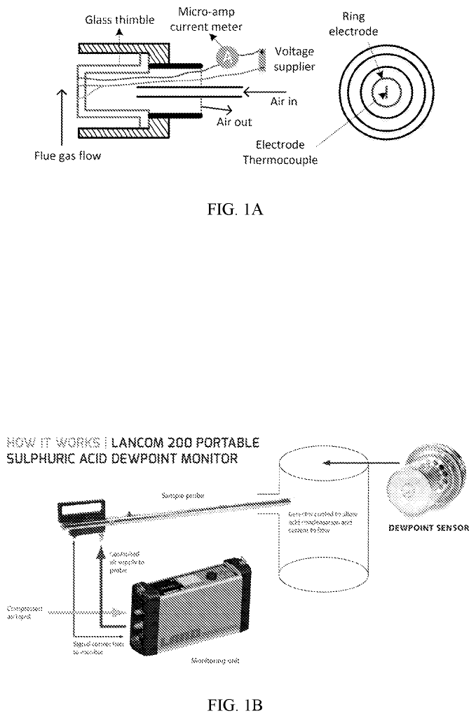

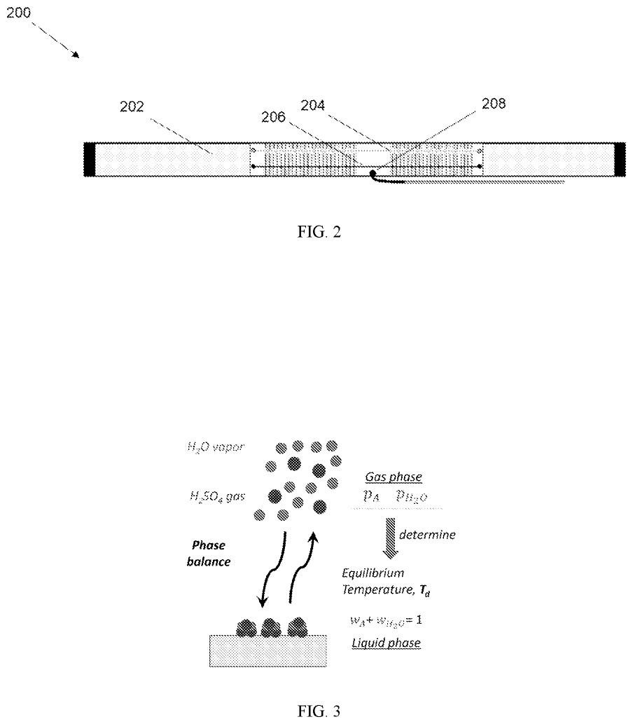

### DETAILED DESCRIPTION OF THE DISCLOSURE

The present disclosure describes a sample cell for a dew point meter. The sample cell includes a flow channel configured to receive a gas sample. The flow channel includes a non-mirror window surface. The flow channel is configured to allow a first optical beam originating from an optical source to impinge on the non-mirror window surface. Then from this surface, a second optical beam leaves towards an optical detector.

In some embodiments, the difference between the second optical beam and the first optical beam results from light scattering and/or absorption of the first optical beam by a liquid component on the non-mirror window surface and/or a liquid component in the gas sample.

In some embodiments, a window surface is behind the non-mirror window surface such that it transmits through the second optical beam towards the opposite side of the optical source.

In some embodiments, a reflective surface is behind the non-mirror window surface such that it reflects the first optical beam and/or the second optical beam back towards the side of the optical source.

In some embodiments, the flow channel is configured to receive a flue gas sample or an industrial gas sample. In some embodiments, the flue gas sample comprises sulfuric acid vapor and/or sulfur trioxide vapor.

In some embodiments, the flow channel is configured to operate at vacuum pressure, atmosphere pressure, and/or high pressure.

In some embodiments, the flow channel is configured to operate at room temperature and/or high temperature.

In some embodiments, the non-mirror window surface comprises a hydrophobic component. In some embodiments, the non-mirror window surface is a hydrophobic surface and/or is coated with a hydrophobic material. In some embodiments, the hydrophobic component may be, but is not limited to, ceramic and/or polytetrafluoroethylene (PTFE).

In some embodiments, the non-mirror window surface comprises an acid corrosion resistant component. In some embodiments, the non-mirror window surface is acid corrosion resistant and/or is coated with an acid corrosion resistant material. In some embodiments, the acid corrosion resistant component may be, but is not limited to, ceramic and/or polytetrafluoroethylene (PTFE). The coated material is but not limited to ceramic and PTFE.

In some embodiments, the flow channel is configured to allow the flue gas sample to impinge on the non-mirror window surface.

In some embodiments, the flow channel is configured to monitor and control the temperature of the non-mirror window surface and/or the temperature of the gas sample.

The present disclosure also describes a dew point meter that includes the sample cell described herein. The dew point meter includes the sample cell, an optical source configured to produce the first optical beam, and an optical detector configured to receive the second optical beam.

In some embodiments, the second optical beam includes the scattering beam from the non-mirror window surface. The optical detector may be configured to measure the second optical beam, including the scattering beam from the non-mirror window surface. In some embodiments, the optical detector is configured to measure the forward scattering within the angle of 0-30°.

The present disclosure also describes a method of measuring a dew point. The method includes receiving a gas sample in a sample cell for a dew point meter, controlling a temperature of the non-mirror window surface and/or a portion of the gas sample to produce a liquid component on the non-mirror window surface and/or in the gas sample, and measuring the dew point of the gas sample with the dew point meter.

In some embodiments, the temperature of the non-mirror window surface and/or the temperature of the gas sample is gradually decreased, and this temperature is recorded as the dew point when there is a difference between the first optical beam and the second optical beam.

In many embodiments, the temperature of the non-mirror window surface and/or the gas sample is controlled by a means of temperature control. Generally, temperature control may be achieved with any suitable means of temperature control known in the art.

In some embodiments, temperature control is achieved with a purge gas flow. In some embodiments, temperature control is achieved with a heater and/or cooler. The heater and/or cooler may heat and/or cool by conduction, convection, radiation, or a combination thereof.

In some embodiments, temperature control is achieved with a thermoelectric temperature controller and/or a purge gas. In some embodiments, temperature control of the purge gas is achieved with a heater and/or cooler.

In some embodiments, temperature monitoring is achieved with a thermocouples and/or a thermal infrared sensor.

In some embodiments, the dew point meter is used to measure a concentration of a component in the gas phase based on the dew point. In these embodiments, a higher dew point reflects a higher gas component concentration. For example, by measuring the acid dew point, the sulfuric acid concentration can be measured.

In some embodiments, sulfur trioxide vapor concentration can be measured with the acid dew point meter. Sulfur trioxide is converted to sulfuric acid vapor in the presence of water vapor. Subsequently, the sulfuric acid concentration is measured by the acid dew point meter.

In some embodiments, the sampling gas is guided by a tube that is inside of the flow channel and near the second window surface. In these embodiments, the sampling gas can increase mass transfer from the gas phase to the surface.

Further aspects of the present disclosure are provided by the subject matter of the following clauses:
1. A sample cell for a dew point meter, the sample cell comprising:
a flow channel configured to receive a gas sample, the flow channel comprising:
   a non-mirror window surface,
   wherein the flow channel is configured to allow a first optical beam originating from an optical source to impinge on the non-mirror window surface and output a second optical beam from the non-mirror window surface towards an optical detector.
2. The sample cell of clause 1, wherein the difference between the second optical beam and the first optical beam results from light scattering and/or absorption of the first optical beam by a liquid component on the non-mirror window surface and/or a liquid component in the gas sample.
3. The sample cell of clause 1, wherein a window surface and/or a reflected surface is behind the non-mirror window surface such that it transmits the second optical beam towards the opposite side of the optical source, or it reflects the first optical beam and/or the second optical beam back towards the side of the optical source.
4. The sample cell of clause 1, wherein the flow channel is configured to receive a flue gas sample and/or an industrial gas sample having a flowrate in a range of from about 0.01 L/min to about 1000 L/min, wherein the flue gas sample or the industrial gas sample comprises sulfuric acid vapor in a concentration in a range of from about 1 ppm to about 50 vol % and/or sulfuric trioxide vapor in a concentration in a range of from about 1 ppm to about 50 vol %.
5. The sample cell of clause 1, wherein the flow channel is configured to operate at vacuum pressure in a range of from about 1 kPa to about 100 kPa, atmosphere pressure, and/or high pressure of up to about 40 bar, and wherein the flow channel is configured to operate at room temperature and/or high temperature of up to about 400° C.
6. The sample cell of clause 1, wherein the non-mirror window surface is a hydrophobic surface and/or is coated with a hydrophobic material.
7. The sample cell of clause 1, wherein the non-mirror window surface is an acid corrosion resistant surface and/or is coated with an acid corrosion resistant component.
8. The flow channel of clause 1, wherein the flow channel is configured to allow the gas sample to impinge on the non-mirror window surface.
9. The sample cell of clause 1, wherein the flow channel is configured to monitor and/or control the temperature of the non-mirror window surface and/or the temperature of the gas sample.
10. A dew point meter comprising:
the sample cell of clause 1;
an optical source configured to produce the first optical beam; and
an optical detector configured to receive the second optical beam.
11. The dew point meter of clause 10, wherein the second optical beam includes the scattering beam from the non-mirror window surface.
12. The dew point meter of clause 10, wherein the optical detector is configured to measure the forward scattering within an angle in a range of from about 0° to about 30°.
13. A method of measuring a dew point, the method comprising:
(I) receiving a gas sample in a sample cell for a dew point meter, wherein the sample cell comprises:
   a flow channel configured to receive the gas sample, wherein the flow channel comprises:
      a non-mirror window surface,
   wherein the flow channel is configured to allow a first optical beam originating from an optical source to impinge on the non-mirror window surface and output a second optical beam from the non-mirror window surface towards an optical detector;
(II) controlling a temperature of the non-mirror window surface and/or a portion of the gas sample to produce a liquid component on the non-mirror window surface and/or in the gas sample; and
(III) measuring the dew point of the gas sample with the dew point meter.
14. The method of clause 13, wherein the difference between the second optical beam and the first optical beam results from light scattering and/or absorption of the first optical beam by a liquid component on the non-mirror window surface and/or in the gas sample.
15. The method of clause 13, wherein a window surface and/or a reflected surface is behind the non-mirror window surface such that it transmits the second optical beam towards the opposite side of the optical source, or it reflects the first optical beam and/or the second optical beam back towards the side of the optical source.
16. The method of clause 13, wherein the flow channel is configured to receive a flue gas sample and/or an industrial gas sample, wherein the flue gas sample and/or industrial gas sample comprises sulfuric acid and/or sulfur trioxide.
17. The method of clause 13, wherein the flow channel is configured to operate at vacuum pressure in a range of from about 1 kPa to about 100 kPa, atmosphere pressure, and/or high pressure of up to about 40 bar, and wherein the flow channel is configured to operate at room temperature and/or high temperature of up to about 400° C.
18. The method of clause 13, wherein the non-mirror window surface is a hydrophobic surface and/or is coated with a hydrophobic material.
19. The method of clause 13, wherein the non-mirror window surface is an acid corrosion resistant surface and/or is coated with an acid corrosion resistant component.
20. The method of clause 13, wherein the flow channel is configured to allow the flue gas sample to impinge on the non-mirror window surface.
21. The method of clause 13, wherein the flow channel is configured to monitor and/or control the temperature of the non-mirror window surface and/or the temperature of the gas sample.
22. The method of clause 13, wherein the temperature of the non-mirror window surface and/or the temperature of the gas sample is gradually decreased, and wherein the temperature is recorded as the dew point when there is a difference between the first optical beam and the second optical beam.
23. The method of clause 13, wherein the second optical beam includes the scattering beam from the non-mirror window surface.
24. The method of clause 13, wherein the optical detector is configured to measure the forward scattering within an angle in a range of from about 0° to about 30°.

### EXAMPLES

Without further elaboration, it is believed that one skilled in the art using the preceding description can utilize the present disclosure to its fullest extent. The following Examples are, therefore, to be construed as merely illustrative, and not limiting of the disclosure in any way whatsoever. It is understood that any numerical range recited herein includes all values from the lower value to the upper value. For example, if a range is stated as 10-50, it is intended that values such as 12-30, 20-40, or 30-50, etc., are expressly enumerated in this specification. These are only examples of what is specifically intended, and all possible combinations of numerical values between and including the lowest value and the highest value enumerated are to be considered to be expressly stated in this application.

In these examples, the theories of the acid dew point and the vapor condensation are analyzed and discussed. The designs of the dew point meter and the calibration system are described. The test system and procedures are introduced. Finally, the test results are presented and discussed.

### Theory of Acid Dew Point

### Physical Meaning of Acid Dew Point

Dew point is a gas-phase property, which can be used to predict gas condensation. The definition of the acid dew point can be established in the phase equilibrium system of H₂SO₄—H₂O, as shown in FIG. 3. The mass transfer of each component between the gas phase and liquid phase is dynamically balanced. The compositions of liquid and gas phase are stable and the temperatures of the liquid phase and gas phase are equal (equilibrium temperature). The acid dew point of the gas phase (Ta) can be defined as the equilibrium temperature. It should be noted that H₂SO₄ vapor can decompose to SO₃ and H₂O, depending on the temperature. For temperatures less than 400° C., the concentration of SO₃ can be ignored. Based on the Gibbs rule, two independent parameters determine the two-component phase equilibrium system. Therefore, the partial pressures of H₂SO₄ vapor (p_{A}) and H₂O vapor (p_{H}_{₂}_{O}) can determine the acid dew point and composition of the liquid phase (w_{A}). Higher acid dew point indicates higher content of acid-water vapor. For engineering applications, the acid dew point can be defined through the solid surface temperature. If the surface temperature is above the acid dew point, there will be no sulfuric acid condensate on the surface. Once the surface temperature is below the acid dew point, the H₂SO₄—H₂O vapor begins to condense.

Mass Transfer of H₂SO₄—H₂O Vapor Condensation on a Solid Surface

The vapor condensation process on a solid surface is normally applied to measure the acid dew point. A model to understand the relationship between the acid dew point and a detectable parameter is the foundation of the acid dew point meter. According to Fick's law, the H₂SO₄ vapor transfer is driven by the p_{A} gradient in the gas-phase boundary layer above the solid surface during the condensation process. The H₂SO₄ vapor mass transfer rate (G_{A}, kg/(m²·s)) can be written as (1):

$${G}_{A} = k ( {p}_{A , g} - {p}_{A , s} ) \qquad ( 1 )$$

where k (kg/(m²·s·pa)) is the H₂SO₄ vapor mass transfer coefficient, p_{A,g} and p_{A,s} (Pa) are the H₂SO₄ vapor partial pressures in the bulk gas and the gas-solid interface, respectively. Gmitro and Vermeulen performed thermodynamic calculations on the vapor-liquid equilibrium for aqueous sulfuric acid, and obtained tables of p_{A}, p_{H}_{₂}_{O} at different T_{d} and weight fractions of sulfuric acid in the condensates (w_{A}). The below relations were established based on these tables,

$${p}_{A} = 1090 {p}_{{H}_{2} O}^{- 2.16} {e}^{0.11 {T}_{d}} \qquad ( 2 )$$

$${w}_{A} = 0.00237 {T}_{d} + 0.467 \qquad ( 3 )$$

where p_{A} is in the range of 1-150 Pa, p_{H}_{₂}_{O} is in the range of 5000-20000 Pa, T_{d} is in the range of 90~180° C. and w_{A} is in the range of 70-90 wt. %. It was found that p_{H}_{₂}_{O} had little influence on w_{A} of the condensate in these ranges; therefore, p_{H}_{₂}_{O} does not appear in Eq. (3). In terms of Eq. (2), p_{A,g} and p_{A,s} in Eq. (1) can be written as Eqs. (4) and (5).

$${p}_{A , g} = 1090 {p}_{{H}_{2} O}^{- 2.1 \; 6} {e}^{0.11 {T}_{d}} \qquad ( 4 )$$

It is assumed that the gas at the gas-solid interface reaches equilibrium with the liquid condensates on the surface. The equilibrium temperature at the gas-solid interface is equal to the surface temperature, Tₛ. Thus,

$${p}_{A , S} = 1090 {p}_{{H}_{2} O}^{- 2.16} {e}^{0.11 {T}_{s}} . \qquad ( 5 )$$

The difference in p_{H}_{₂}_{O} in the bulk gas and the gas-solid interface can be ignored since the amount of water condensing is several orders of magnitude less than the amount of water vapor in the gas phase. Thus, the same p_{H}_{₂}_{O} in Eqs. (4) and (5) can be used. Based on Eqs. (1), (4) and (5),

$${G}_{A , s} = k \cdot {p}_{A , g} \cdot \{ 1 - {e}^{- 0.11 ( {T}_{d} - {T}_{s} )} \} . \qquad ( 6 )$$

T_{d}−Tₛ is the excess temperature and is the key term that drives the condensation process. As the excess temperature increases, the condensation rate of H₂SO₄ vapor on the surface asymptotically approaches the maximum (G_{Ao}), which is proportional to the p_{A,g} as shown in Eq. (7).

$${G}_{A o} = k \cdot {p}_{A , g} \qquad ( 7 )$$

G_{Ao} is extremely small due to the ultra-low content of H₂SO₄ vapor. It should be noted that the form of Eq. (6) is similar to Land's theoretical model without fog formation. There it was found that there would be some acid-water fog formation in the gas phase near the surface at large excess temperature (>20° C.), and this decreased the amount of condensate on the solid surface.

The H₂SO₄ vapor mass transfer coefficient (k) is analyzed through nondimensional analysis. There are three dimensionless numbers for determining k: the Sherwood number, Sh, the Reynolds number, Re and the Schmidt number, Sc. For laminar flow along a plate, the relationship between the three numbers is:

$$S {h}_{L} = 0.664 {Re}_{L}^{0.5} S {c}^{0.33} ( Re < 2 \times 1 {0}^{5} ) \qquad ( 8 )$$

$$\frac{{k}_{c} L}{{D}_{A}} = 0.664 {( \frac{ρ u L}{μ} )}^{0.5} {( \frac{μ}{ρ {D}_{A}} )}^{0.33} \qquad ( 9 )$$

where L is the length of plate (m), D_{A} is the diffusion coefficient of H₂SO₄ vapor (m²/s), ρ is the density of the flue gas (kg/m³), μ is the viscosity of the flue gas (Pas) and u is the gas velocity (m/s). Since k_{c} is defined as the mass (mol) transfer per square area (m²) per second(s) per concentration difference (mol/m³), there is a conversion from k_{c} to k given by

$$k = \frac{{ρ}_{A}}{{p}_{g}} {k}_{c} \qquad ( 10 )$$

where ρ_{A} is the density of H₂SO₄ vapor (kg/m³) and p_{g} is the total pressure of gas (Pa). Based on Eqs. (8-10), increasing the gas velocity near the surface can enhance the mass transfer of H₂SO₄ vapor.

Since H₂O vapor condensation is motivated by H₂SO₄ vapor condensation, the H₂O vapor transfer rate can be obtained through the weight ratio of H₂O—H₂SO₄ (f) in the condensate:

$$f = \frac{{w}_{{H}_{2} O}}{{w}_{A}} = \frac{1 - {w}_{A}}{{w}_{A}} = \frac{0.533 - 0.00237 {T}_{d}}{0.00237 {T}_{d} + 0.467} \qquad ( 11 )$$

The mass transfer rate of the H₂O vapor (G_{H}_{₂}_{O,s}) can be expressed as

$${G}_{{H}_{2} O , s} = f \cdot {G}_{A , s} . \qquad ( 12 )$$

This suggests that G_{H}_{₂}_{O,s} is of the same magnitude as G_{A,s}. Both G_{A,s} and G_{H}_{₂}_{O,s} would be very small due to the small concentration of H₂SO₄ vapor. Therefore, the condensation of H₂O vapor has a minor influence on the p_{H}_{₂}_{O} in Eq. (5).

The condensation rate of H₂SO₄/H₂O vapor (Gₛ) can be derived as

$${G}_{S} = {G}_{A , s} + {G}_{{H}_{2} O , s} = ( 1 + f ) {G}_{A , s} = ( 1 + f ) {G}_{A o} \{ 1 - {e}^{- 0.11 ( {T}_{d} - {T}_{s} )} \} . \qquad ( 13 )$$

Eq. (13) establishes a physical connection between the acid dew point and the condensation rate of aqueous sulfuric acid. This relationship can be applied to measure the acid dew point. The condensation rate on the surface is determined by the excess temperature, the acid content in the bulk gas and the mass transfer coefficient. Increasing these parameters can enhance the mass transfer from the gas to the surface.

### The Acid Dew Point Meter and its Calibration System

### Basic Design of the Acid Dew Point Meter

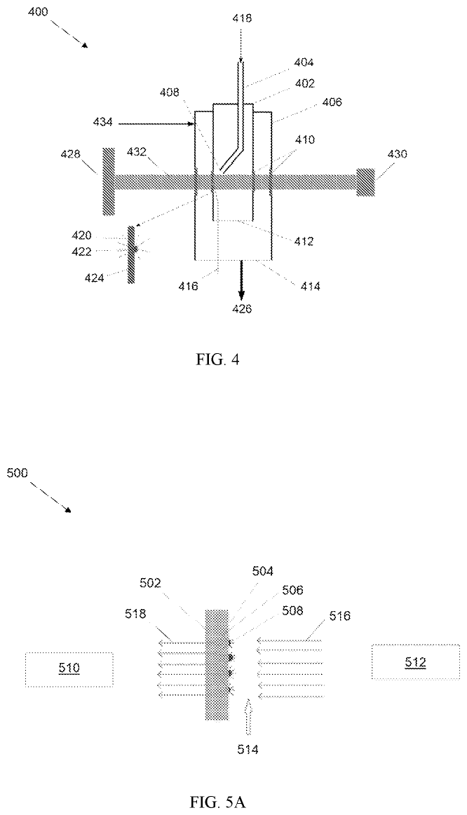

An acid dew point meter 400 is shown in FIG. 4. The acid dew point meter 400 includes a sampling cell 402, sampling flow channel 404, purge flow channel 406, outlet of sampling flow channel 408, optical windows 410, outlet of sampling cell 412, outlet of purge flow channel 414, and thermocouple 416 with ultra-thin bead. The thermocouple includes an optical window with a hydrophobic surface 424 that is configured to receive a condensate 422 on it, which results in scattering 420 of light from an optical beam 432 emitted by a laser emitter 430. The scattered light passes to a light scattering detector 428. Sampling flow 418 and purge gas flow 434 separately enter the sampling cell 402 and exit as a gas mixture 426.

As Eq. (13) shows, a small excess temperature can drive vapor condensation on a solid surface. Based on this, by slowly cooling the surface and recording its temperature when condensate first appear, an approximate acid dew point can be obtained. If the excess temperature is small when condensate is detected, the measured results are more accurate. However, the condensation rate is extremely small with small excess temperature. Therefore, this meter must be capable of monitoring a miniscule amount of condensate. To achieve this, as shown in FIG. 4, a hydrophobic window surface is used to condense the vapor and let a collimated beam pass through the window. The surface temperature is measured by a thermocouple with an ultra-thin bead. Once there is a small excess temperature, vapor transfers to the surface and forms dispersed nucleation sites, which grow to small-sized droplets (0.1-100 micron), and these droplets scatter light from the laser. The hydrophobic property of the surface enables a larger contact angle for the droplets and this enhances light scattering. A high sensitivity optical detector is used to monitor light scattering.

In FIG. 4, a sampling cell is used to guide the sampling gas to the hydrophobic window surface. This window is mounted on the sampling cell. As Eq. (9) suggests, a higher gas velocity near the window surface will enhance mass transfer. To achieve this, a sampling channel with a small diameter was used to direct the flow to the surface, as this greatly improves the measurement sensitivity. To control the surface temperature, a channel guides a purge flow to the opposite side of the window. The outside of the sampling cell is thermally insulated to minimize heat loss from the walls. The purge flow merges with the sampling flow at the sampling cell outlet, which can significantly dilute the sampling flow and avoid condensation downstream of the sampling cell.

### Configurations of the Acid Dew Point Meter

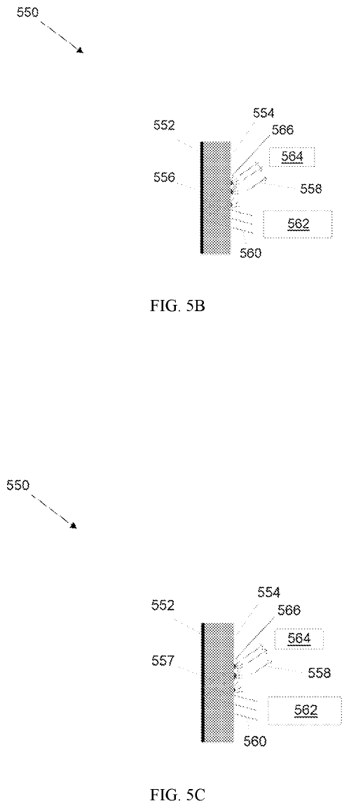

The scattering configuration 500 of the acid dew point meter 400 is shown in FIG. 5A. An optical source 512 emits a first optical beam 516 that passes through a gas sample 514 and through a window surface 502 that includes a non-mirror window surface 504 onto which a liquid component 508 is condensed. This results in a scattering beam 506. A second optical beam 518 including the first optical beam 516 and the scattering beam 506 is emitted through the window surface 502 towards a detector 510. The detector 510 measures the transmission and forward scattering between 0-30 degrees.

FIG. 5A shows the features of the basic design in FIG. 4, in which there is a window surface behind the non-mirror window surface. When there is a reflected surface behind the non-mirror window surface, the first optical beam can be reflected backwards and transmitted through the non-mirror window surface. In this way, the optical emitter and detector can be on one side, which enables a more compacted design. When the first optical beam does not encounter the liquid component before reflection, there is no scattering beam from the liquid component reflecting on the reflected surface.

The scattering configuration 550 of the acid dew point meter 400 is shown in FIG. 5B. An optical source 562 emits a first optical beam 560 that passes through a gas sample (not shown) and through a non-mirror window surface 554 onto which a liquid component 566 is condensed to a reflect surface (e.g., mirror) 552 that reflects the first optical beam 556. A second optical beam 558 including the scattering passes to a detector 564.

An alternative scattering configuration 550 of the acid dew point meter 400 is shown in FIG. 5C. An optical source 562 emits a first optical beam 560 that passes through a gas sample (not shown) and through a non-mirror window surface 554 onto which a liquid component 566 is condensed to a reflect surface (e.g., mirror) 552 that reflects the first optical beam 557 and includes the scattering beam. A second optical beam 558 including the scattering passes to a detector 564.

As FIGS. 5B-5C show, when the first optical beam encounters with a liquid component, the forward scattering from the liquid component can be also reflected on the reflected surface.

### Application: Measurement of Dew Point at High Pressure

For measurement of dew point at high pressure, the purge flow channel and sampling cell are installed inside of a pressure vessel. The outer windows are mounted on the wall of the pressure vessel and are rated for the operating pressure and temperature of the system. Four inner windows that are installed on the purge flow channel and the sampling cell, while not pressure sealed, are able to perform at operating temperature. The inner and outer windows are aligned with the optical beam zone. The clear aperture sizes of the inner and outer windows are large enough to allow the scattering light that is to be measured by the detector to pass through the windows.

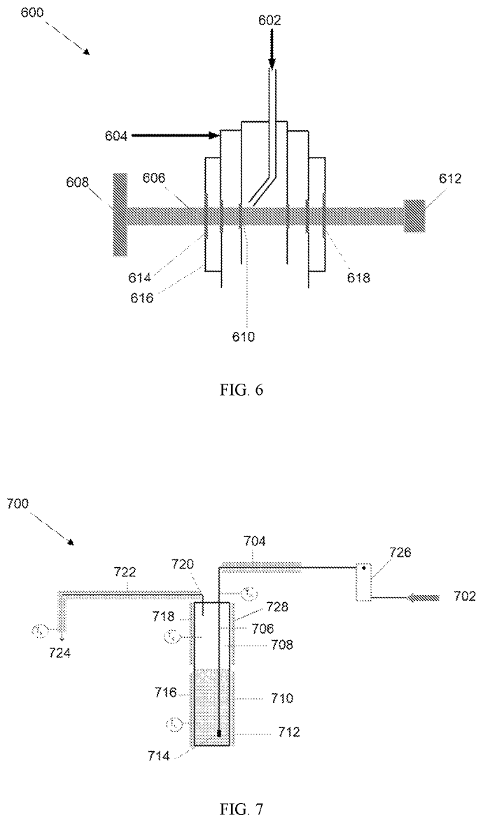

FIG. 6 depicts a high-pressure dew point meter 600 that differs from the dew point meter 400 by including a high-pressure cell contained in a pressure vessel 616. Sampling flow 602 and purge flow for temperature control 604 separately enter the dew point meter 600. An optical beam 606 is emitted by a laser emitter 612 and passes through a first pressure window 618, a thermocouple 610 with ultra-thin bead, and a second pressure window 614. The optical beam 606 is received at a detector 608 capable of detected scattering.

### The Acid Dew Point Calibration System

Based on the definition of the acid dew point introduced above, an acid dew point calibrator was proposed and designed. In some embodiments, the acid dew point calibrator consists of a vapor-liquid (95-98 wt % H₂SO₄) equilibrium system in a quartz cylinder vessel. The acid dew point of the gas phase is equal to the temperature of liquid and gas (T_{L} and T_{g}). The vessel is maintained with a uniform temperature distribution with two heaters (Heater-2 and -3), and thus T_{L} and T_{g} are equal. To take a sampling gas flow from the vessel, a gas dispersion tube (borosilicate) was used to direct a carrier flow (air or nitrogen) to the bottom of liquid. A heater (Heater-1) on the gas inlet line is used to control the carrier gas temperature (Tᵢₙ) so that Tᵢₙ is equal to T_{L} and T_{g}, which maintains a uniform temperature distribution inside of the quartz vessel. When the carrier gas flows through the porous material, tiny gas bubbles are formed. These gas bubbles can be rapidly saturated with the acid, and thus will not break the phase equilibrium inside of the bubbler. However, due to the bursting of bubbles above the liquid surface, some droplets exit the bubbler in the sampling flow. These droplets could deposit on the surfaces of sampling line, which would influence the acid content in the sampling gas if the temperature of the sampling lines is higher than the bubbler temperature. To avoid this bias, it is necessary to ensure that the temperature of the sampling line is the same as that of bubbler (Heater-4).

An exemplary embodiment of an acid dew point calibrator 700 is shown in FIG. 7. Clean air or N₂ 702 passes through a flow meter 726 and through a first heater 704 to a bubbler 728 including a gas inlet line 706, a gas phase 708 with saturated H₂SO₄ vapor, gas bubbles 710, liquid phase with 95-98% sulfuric acid, a gas dispersion tube 714 (e.g., made from borosilicate), a second heater 716, a third heater 718. Inside the bubbler 728, the liquid and gas phases reach equilibrium of T_{L}=T_{g}. The flow passes through a gas outlet line 720 having a fourth heater and then sampling gas containing H₂SO₄ vapor 724, with an acid dew point equal to T_{L} exits the acid dew point calibrator 700.

### Test

An Insitec analyzer (Malvern Panalytical) is used for the laser emitter (670 nm) and scattering detector in the acid dew point meter. The Insitec has been widely applied for droplet analysis via measurement of light scattering in the gas phase. In the present configuration, the forward scattered beams from the condensate are collected and focused onto a detector array, which consists of 32 individual co-annular ring detectors (the two innermost detectors, Detector-1 and -2, are not used). Each ring detector can measure light scattered at defined ranges. From the smallest angle (Detector-3) to the largest angle (Detector-32), the area of a ring detector increases exponentially by about 3 orders of magnitude to capture the weak signal at larger angles. The RTSizer software, which serves as the interface for the Insitec analyzer, allows us to monitor the scattering signal in real-time.

In some embodiments, the dew point meter cell can work under high pressure. In some of these embodiments, the pressure vessel of such a cell is a 2-inch Schedule 40 stainless steel (316) pipe. To mount the pressure bearing windows, two weld bungs are welded symmetrically to the pipe. A stainless-steel pipe (316) that is inside of the pressure vessel, referred to as the “middle pipe”, is used for the purge-flow channel. There are two thin window holders welded on the middle pipe to mount the inner windows, which are aligned with the pressure windows. A ¾-inch stainless steel (316) tube is installed in the center of the middle pipe to serve as the sampling cell. The outside of sampling cell tube is insulated with PTFE. The hydrophobic window is mounted on the holder of sampling cell. A ⅛-inch tube is inserted into the sampling cell to inject the sampling flow to the hydrophobic surface. The pressure bearing and inner windows are optical grade and have anti-reflection coatings on both surfaces. This can greatly enhance signal-to-background ratio and thus improve the measurement sensitivity. In the tested application, for the outer optical windows, two high-quality C-plane sapphire windows (Encole LLC) are used. For the inner windows on the middle pipe, two high-quality N-BK7 windows are used. The hydrophobic window (Edmund Optics), installed in the sampling cell minimizes reflections and is resistant to corrosion from sulfuric acid. A K-type thermocouple bead (0.002-inch) is attached to the hydrophobic surface and covered with epoxy.

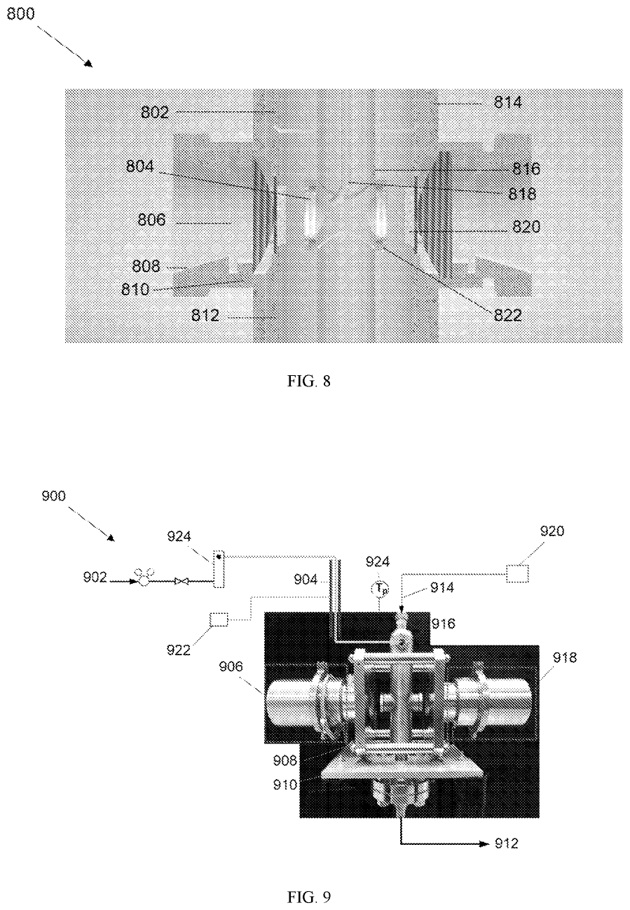

FIG. 8 shows an exemplary embodiment of a dew point meter cell 800 which can work under high pressure. The dew point meter cell 800 includes an upper part 802 of a middle pipe 812, a hydrophobic window 804, a pressure bearing window 806, a titanium housing 808, a weld bung 810, a middle pipe 812, a 2-inch pipe as a pressure vessel 814 (e.g., schedule 40 pipe), a ¾ inch tube 816, a ⅛ inch tube 818, an inner window 820, and a hydrophobic window holder 822.

In some embodiments, a test system for the acid dew point meter, consisting of the optical instrument, the dew point meter cell, the calibrator and the purge flow control system, may be assembled. In some of these embodiments, the Insitec emitter module (left) and receiver module (right) are rigidly attached to the Insitec open frame which aligns the two modules. The Insitec open frame and the dew point cell are mounted on a metal stand. There are mechanisms that allow for multiple degrees of freedom on the stand to allow for alignment of the Insitec and the acid dew point meter cell. The purge gas temperature is controlled by a heating tape to smoothly change the temperature of the hydrophobic surface. The sampling gases with a known acid dew point (100° C. or 55° C.) flow from the bubbler into the acid dew point meter for testing. The 95-98% sulfuric acid liquid at 100° C. can produce around 170 ppm H₂SO₄ vapor, which serves as a rapid test condition. However, the 95-98% sulfuric acid at 55° C. can only produce about 6 ppm acid vapor, which may serve as an extreme test condition. For the testing procedures, as a first step, a hot purge gas flow was used to heat up the entire sampling cell, including the windows, to a temperature above the estimated dew point. In the second step, the hydrophobic surface temperature was slowly decreased by reducing the power input into the purge gas heater. Then, the surface temperature was recorded when a scattering signal first appears to obtain the acid dew point. Finally, the surface temperature was increased by increasing the power input to the purge gas heater, so as to fully evaporate the condensate and prepare for the next measurement cycle.

FIG. 9 shows an exemplary embodiment of a test system 900. Test system 900 includes clean compressed air 902 as purge flow that flows through a regulator, valve, and rotameter 924. A voltage controller 922 controls a heater 904 and heating is measured by a thermocouple 924. The purge flow enters the dew point meter cell 916. Simultaneously, sampling gas 914 from a dew point calibration system 920 flows to the dew point meter cell 916. An emitter module 918 sends light through the dew point meter cell 916, which is received at the receiver module 906. The dew point meter cell 916 is supported by an Insitec open frame 908 and a mounting stand 910. Mixed gas exits to vent 912.

### Results and Discussions

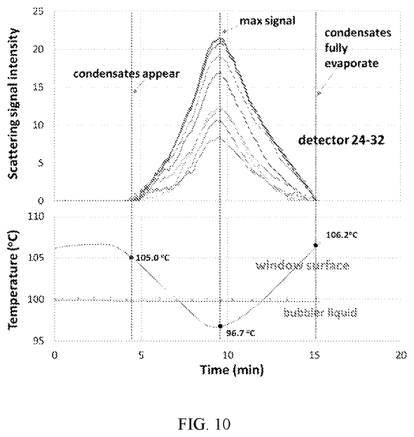

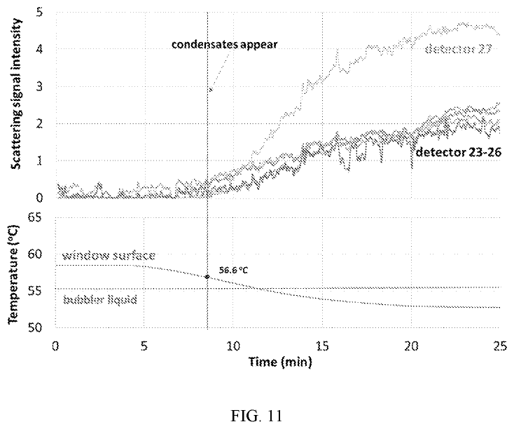

The test results show that the dew point meter can succeed in measuring the sulfuric acid dew point even at an extreme low content of H₂SO₄ vapor (around 6 ppm). This acid dew point meter has proven to be more sensitive and accurate than commercial meters. As FIGS. 10 and 11 show, for the bubbler liquid temperatures at 100.0° C. and 55.3° C. in the calibrator, the measured acid dew points are around 105.0° C. and 56.6° C., respectively. FIG. 10 shows a full measurement cycle for the acid dew point of the sampling flow which contains around 170 ppm acid vapor. When the surface temperature is around 107° C., the scattering signals are zero and thus there should be no condensate or droplets. Once the surface temperature slowly decreases to below 105° C., the scattering signals appear and start to increase, which means condensation is occurring. Based on this, the measured acid dew point should be around 105° C., which is 5° C. higher than the bubbler temperature (100° C.). This error is probably due to the calibrator instead of the measurement itself. There could be some hot spots (around 105° C.) in the sampling line which would heat the droplets on the wall and thus increase the acid dew point in the sampling gas. To avoid this, a more uniform temperature control for the sampling line is needed. The scattering signals increase rapidly as the surface temperature keeps decreasing, which indicates that there is more condensate with larger excess temperature, as expected. After the temperature stops to decrease and begins to increase again, the scattering signals show a peak at 96.7° C., and then significantly decreases, which indicates that the condensed droplets are evaporating even when the surface temperature is lower than the acid dew point. This suggests that there could be a saturated amount of condensate on the surface at an excess temperature. With smaller excess temperature, the amount of condensate is less. When the surface temperature reaches around 106.2° C., the scattering signal is zero which means the condensate is fully evaporated.

FIG. 11 shows the acid dew point measurement when the bubbler temperature is around 55.3° C. (acid vapor content is only 6 ppm). In this extreme case, the sampling line temperatures were carefully monitored and controlled to around 55° C. and any possible hot spots in the sampling line were avoided. When the hydrophobic surface temperature is kept around 58° C., the scattering signals are zero. This verifies that no droplets are coming directly from the bubbler liquid and depositing on the hydrophobic surface. When the hydrophobic surface temperature is slowly decreased to about 56.6° C., the scattering signals start to increase and thus condensate appears. The measured result (56.6° C.) is much closer to the acid dew point (55.3° C.) with only 1.3° C. error. The range in which a difference in scattering signal intensity appears (0-5) is much smaller than what is seen in FIG. 10 (signal intensity difference range is 0-25). The rate of increase in signal intensity in FIG. 11 is much smaller as well, as compared with FIG. 10. This is because the ultra-low acid vapor content results in a much slower condensation rate, which agrees with the above analysis. In FIG. 11, when the surface temperature is stable, the scattering signals are effectively stable, which means the condensation rate has decreased to zero. At this moment, there is an excess temperature but there is no condensation. Similar to the discussion for FIG. 10, this also suggests that there should be a saturated amount of condensate at each excess temperature.

### CONCLUSION

In this disclosure, a novel dew point meter was proposed and designed based on measuring the light scattering from vapor condensate on a hydrophobic window surface. The acid dew point theory was discussed and analyzed. An acid dew point calibration system was established based on the vapor-liquid equilibrium inside of a liquid H₂SO₄ bubbler. The test results show that this dew point meter can succeed in measuring the sulfuric acid dew point with a much higher accuracy and sensitivity than that of commercial meters. Even at an extremely low concentration of H₂SO₄ vapor (about 6 ppm), this meter is capable of measuring an accurate result with an error of only 1.3° C.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

To facilitate the understanding of the embodiments described herein, a number of terms are defined below. The terms defined herein have meanings as commonly understood by a person of ordinary skill in the areas relevant to the present disclosure. Terms such as “a,” “an,” and “the” are not intended to refer to only a singular entity, but rather include the general class of which a specific example may be used for illustration. The terminology herein is used to describe specific embodiments of the disclosure, but their usage does not delimit the disclosure, except as outlined in the claims.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that vary depending upon the desired properties sought to be obtained by a particular embodiment. In some embodiments, the numerical parameters are be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) are construed to cover both the singular and the plural, unless specifically noted otherwise. In some embodiments, the term “or” as used herein, including the claims, is used to mean “and/or” unless explicitly indicated to refer to alternatives only or to refer to the alternatives that are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and may also cover other unlisted steps. Similarly, any composition or device that “comprises,” “has” or “includes” one or more features is not limited to possessing only those one or more features and may cover other unlisted features.

All methods described herein are performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member is referred to and claimed individually or in any combination with other members of the group or other elements found herein. One or more members of a group are included in, or deleted from, a group for reasons of convenience or patentability. When any such inclusion or deletion occurs, the specification is herein deemed to contain the group as modified thus fulfilling the written description of all Markush groups used in the appended claims.

All of the compositions and/or methods disclosed and claimed herein may be made and/or executed without undue experimentation in light of the present disclosure. While the compositions and methods of this disclosure have been described in terms of the embodiments included herein, it will be apparent to those of ordinary skill in the art that variations may be applied to the compositions and/or methods and in the steps or in the sequence of steps of the method described herein without departing from the concept, spirit, and scope of the disclosure. All such similar substitutes and modifications apparent to those skilled in the art are deemed to be within the spirit, scope, and concept of the disclosure as defined by the appended claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A sample cell for a dew point meter, the sample cell comprising:
a flow channel configured to receive a gas sample, the flow channel comprising:
a non-mirror window surface,
wherein the flow channel is configured to allow a first optical beam originating from an optical source to impinge on the non-mirror window surface and output a second optical beam from the non-mirror window surface towards an optical detector.

2. The sample cell of claim 1, wherein the difference between the second optical beam and the first optical beam results from light scattering and/or absorption of the first optical beam by a liquid component on the non-mirror window surface and/or a liquid component in the gas sample.

3. The sample cell of claim 1, wherein a window surface and/or a reflected surface is behind the non-mirror window surface such that it transmits the second optical beam towards the opposite side of the optical source, or it reflects the first optical beam and/or the second optical beam back towards the side of the optical source.

4. The sample cell of claim 1, wherein the non-mirror window surface is a hydrophobic surface and/or is coated with a hydrophobic material.

5. The sample cell of claim 1, wherein the non-mirror window surface is an acid corrosion resistant surface and/or is coated with an acid corrosion resistant component.

6. The flow channel of claim 1, wherein the flow channel is configured to allow the gas sample to impinge on the non-mirror window surface.

7. The sample cell of claim 1, wherein the flow channel is configured to monitor and/or control the temperature of the non-mirror window surface and/or the temperature of the gas sample.

8. A dew point meter comprising:
the sample cell of claim 1;
an optical source configured to produce the first optical beam; and
an optical detector configured to receive the second optical beam.

9. The dew point meter of claim 8, wherein the second optical beam includes the scattering beam from the non-mirror window surface.

10. The dew point meter of claim 8, wherein the optical detector is configured to measure the forward scattering within an angle in a range of from about 0° to about 30°.

11. A method of measuring a dew point, the method comprising:
(I) receiving a gas sample in a sample cell for a dew point meter, wherein the sample cell comprises:
a flow channel configured to receive the gas sample, wherein the flow channel comprises:
a non-mirror window surface,
wherein the flow channel is configured to allow a first optical beam originating from an optical source to impinge on the non-mirror window surface and output a second optical beam from the non-mirror window surface towards an optical detector;
(II) controlling a temperature of the non-mirror window surface and/or a portion of the gas sample to produce a liquid component on the non-mirror window surface and/or in the gas sample; and
(III) measuring the dew point of the gas sample with the dew point meter.

12. The method of claim 11, wherein the difference between the second optical beam and the first optical beam results from light scattering and/or absorption of the first optical beam by a liquid component on the non-mirror window surface and/or in the gas sample.

13. The method of claim 11, wherein a window surface and/or a reflected surface is behind the non-mirror window surface such that it transmits the second optical beam towards the opposite side of the optical source, or it reflects the first optical beam and/or the second optical beam back towards the side of the optical source.

14. The method of claim 11, wherein the non-mirror window surface is a hydrophobic surface and/or is coated with a hydrophobic material.

15. The method of claim 11, wherein the non-mirror window surface is an acid corrosion resistant surface and/or is coated with an acid corrosion resistant component.

16. The method of claim 11, wherein the flow channel is configured to allow the flue gas sample to impinge on the non-mirror window surface.

17. The method of claim 11, wherein the flow channel is configured to monitor and/or control the temperature of the non-mirror window surface and/or the temperature of the gas sample.

18. The method of claim 11, wherein the temperature of the non-mirror window surface and/or the temperature of the gas sample is gradually decreased, and wherein the temperature is recorded as the dew point when there is a difference between the first optical beam and the second optical beam.

19. The method of claim 11, wherein the second optical beam includes the scattering beam from the non-mirror window surface.

20. The method of claim 11, wherein the optical detector is configured to measure the forward scattering within an angle in a range of from about 0° to about 30°.
